(19) United States
(12) Patent Application Publication
(10) Pub. No.: US 2026/0230593 A1
(43) Pub. Date: Aug. 6, 2026

(54) OPTIMIZED AUGMENTED REALITY (AR) RENDERING AND COMPOSITION PROCESS USING SUPER RESOLUTION TECHNIQUES

(71) Applicant: QUALCOMM Incorporated, San Diego, CA (US)

(72) Inventors: Nilanjan GOSWAMI, Livermore, CA (US); Dam BACKER, San Diego, CA (US)

(21) Appl. No.: 19/044,438

(22) Filed: Feb. 3, 2025

(51) Int. Cl. H04N 13/293; G06T 3/4076; H04N 13/257; H04N 13/275

(52) U.S. Cl. CPC H04N 13/293; G06T 3/4076; H04N 13/257; H04N 13/275

(57) ABSTRACT

A computer implemented method includes rendering a first layer of content at a lower resolution. The method also includes upscaling the lower resolution first layer of content into a higher resolution first layer of content by performing super resolution processing to generate an upscaled first layer of content. The method further includes composing the first layer of content with a second layer of content to generate augmented reality graphics.

### BACKGROUND

Field Aspects of the present disclosure relate to computing devices, and more specifically to rendering and composing augmented reality content.

### BACKGROUND

Mobile or portable computing devices include augmented reality (AR) glasses, virtual reality (VR) headsets, mobile phones, laptop, palmtop and tablet computers, portable digital assistants (PDAs), portable game consoles, and other portable electronic devices. Mobile computing devices are comprised of many electrical components that consume power and generate heat. The components (or compute devices) may include system-on-a-chip (SoC) devices, for example, graphics processing unit (GPU) devices, neural processing unit (NPU) devices, digital signal processors (DSPs), and modems, among others.

High power consumption and performance inefficiencies are issues in all computing devices, but may be more prominent in augmented reality (AR) systems. AR devices, such as glasses and headsets, require significant computational resources to render and compose multiple layers of content. These rendering and composing processes are power-intensive for their form factor, especially when rendering content at high resolutions to ensure a quality visual experience. For example, AR glass devices have very small batteries. Hence, the power budget for tasks are small. It would be desirable to improve power efficiency (e.g., performance per unit power) when rendering, composing, and displaying content on AR devices in order to optimize applications for the device form factor.

### SUMMARY

In aspects of the present disclosure, a computer implemented method includes rendering a first layer of content at a lower resolution. The method also includes upscaling the lower resolution first layer of content into a higher resolution first layer of content by performing super resolution processing to generate an upscaled first layer of content. The method further includes composing the first layer of content with a second layer of content to generate augmented reality graphics.

Other aspects of the present disclosure are directed to an apparatus. The apparatus has one or more memories and one or more processors coupled to the one or more memories. The processor(s) is configured to render a first layer of content at a lower resolution. The processor(s) is also configured to upscale the lower resolution first layer of content into a higher resolution first layer of content by performing super resolution processing to generate an upscaled first layer of content. The processor(s) is further configured to compose the first layer of content with a second layer of content to generate augmented reality graphics.

In other aspects of the present disclosure, a non-transitory computer-readable medium with program code recorded thereon is disclosed. The program code is executed by a processor and includes program code to render a first layer of content at a lower resolution. The program code also includes program code to upscale the lower resolution first layer of content into a higher resolution first layer of content by performing super resolution processing to generate an upscaled first layer of content. The program code further includes program code to compose the first layer of content with a second layer of content to generate augmented reality graphics.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), including an augmented reality (AR) content processing pipeline, in accordance with various aspects of the present disclosure.

FIG. 2 is a block diagram illustrating a first augmented reality content processing pipeline, in accordance with various aspects of the present disclosure.

FIG. 3 is a block diagram illustrating another augmented reality content processing pipeline, in accordance with various aspects of the present disclosure.

FIG. 4 is a flow diagram illustrating an example process performed, for example, by a compute device, in accordance with various aspects of the present disclosure.

FIG. 5 is a block diagram showing an exemplary wireless communications system in which a configuration of the present disclosure may be advantageously employed.

FIG. 6 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Augmented reality (AR) systems render various types of content on multiple layers, which are displayed on AR devices. These layers can be transparent and overlapping, depending on visibility and user orientation. Rendering high resolution content consumes a substantial amount of power, which is an issue for battery operated AR devices. The process of rendering, composing, and displaying multiple layers of content can be computationally intensive and can lead to performance bottlenecks, affecting the smoothness and responsiveness of the AR experience, possibly rendering the product unrealizable. The process of composing sparse and overlapping content (in smaller dimensions with fewer total pixels) may be more power efficient if performed on a smaller number of pixels.

Moreover, transmission power in the AR device may be reduced by rendering content at a lower resolution. More specifically, local graphics processing units (GPUs) may be able to handle processing at a lower resolution, reducing the need for high power transmission between a wearable AR device and a remote processing device. Lower resolution rendering followed by upscaling can match specified frame rates, further saving power, thus making the AR device viable with a longer day of use.

The techniques of the present disclosure start with rendering content at a lower resolution (e.g., two times lower than a standard resolution), thereby saving power. Some techniques then perform low resolution composition of the low resolution layers. Warping and various distortion corrections may also occur at this stage. Super resolution techniques based on upscaling, include spatial and/or temporal super resolution processing, may be performed. Spatial super resolution upscales an image to the desired resolution. Temporal super resolution increases a frame rate by inserting newly generated frames in between rendered frames. Finally, display processing of the upscaled image occurs ensuring the generated image is calibrated to match the display space instead of the rendering space or composition space. Display processing may include, for example, chromatic aberration correction, white point correction, and gamma correction.

Particular aspects of the subject matter described in this disclosure can be implemented to realize one or more of the following potential advantages. In some examples, the described techniques, such as rendering at a low resolution and subsequently performing super resolution upscaling, save power in AR devices compared to performing the entire rendering, composition, and display processing at high resolution. The described techniques also enhance overall performance of AR systems, making AR devices more feasible for prolonged use.

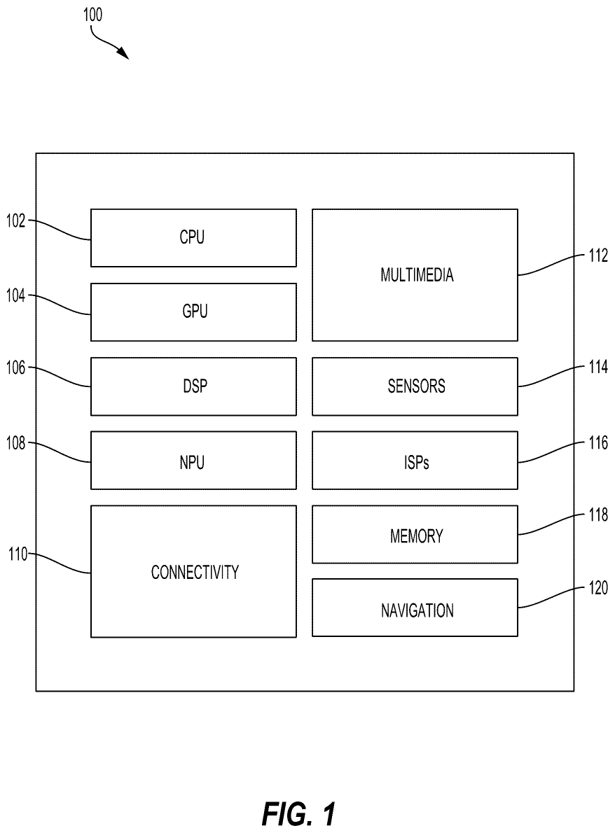

FIG. 1 illustrates an example implementation of a host system-on-a-chip (SoC) 100, which includes an augmented reality (AR) content processing pipeline, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

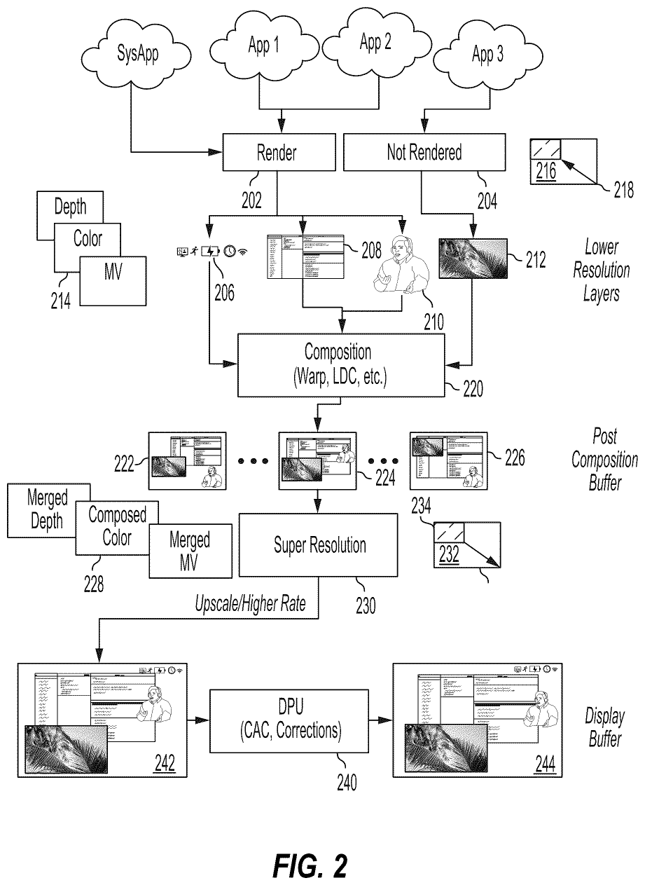

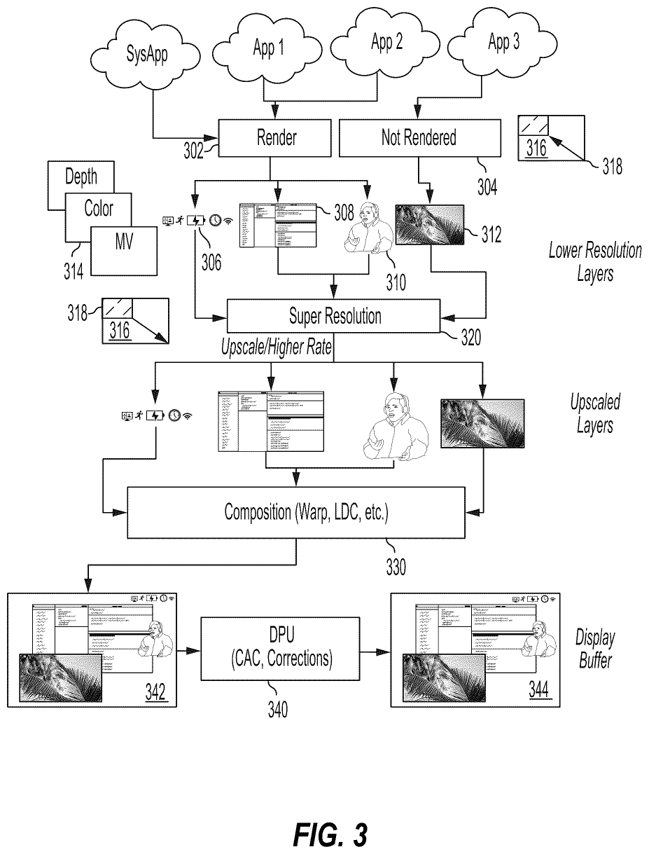

According to aspects of the present disclosure, a mobile device, such as an augmented reality or virtual reality (VR) device includes a processing pipeline. The processing pipeline may include means for rendering, means for upscaling, means for composing, means for correcting, means for warping, and means for performing. In one configuration, the rendering means may be the rendering block 202, 302, as shown in FIGS. 2 and 3. In one configuration, the upscaling means may be the super resolution processing block 230, 320 as shown in FIGS. 2 and 3. In one configuration, the composing means may be the composition block, 220, 330 as shown in FIGS. 2 and 3. In one configuration, the correcting means may be the composition block 220, 330, as shown in FIGS. 2 and 3. In one configuration, the warping means may be the composition block 220, 330, as shown in FIGS. 2 and 3. In one configuration, the performing means may be the display processing unit (DPU) 240, 340, as shown in FIGS. 2 and 3. In other aspects, the aforementioned means may be any structure or any material configured to perform the functions recited by the aforementioned means.

High power consumption and performance inefficiencies are issues in all computing systems, but may be more prominent in augmented reality (AR) systems. AR devices, such as glasses and headsets, require significant computational resources to render and compose multiple layers of content at an ultra low energy budget. These processes are power-intensive, especially when rendering high resolution content. Many layers may include sparsely populated content. This content can be head-locked or world-locked, and often specifies rendering at high resolutions to ensure a quality visual experience. Head-locked content is an example of content, such as a battery indicator, that remains in the same location from the user's perspective, even when the user is moving their head. World-locked content remains stationary in the display world space, regardless of the user's head movement, with the orientation changed accordingly.

Rendering high resolution content consumes a substantial amount of power, which is an issue for battery operated AR devices. Prolonged use of these devices leads to rapid battery drain, making them less practical for everyday use. In addition, very small battery size specifications may render AR products unviable. The process of rendering, composing, and displaying multiple layers of content can be computationally intensive and can lead to performance bottlenecks, affecting the smoothness and responsiveness of the AR experience. The composition of sparse and overlapping content should be handled efficiently to avoid unnecessary power usage. Conventional methods may not optimize the varying visibility and placement of layers, leading to wasted computational resources. High resolution content may also specify significant power consumption for transmission between different components of the AR system, such as from a remote puck-like processing device to the AR glasses. The power required for transmission further exacerbates the power consumption issue. There is a need for reducing power consumption while maintaining high quality visual output.

Aspects of the present disclosure relate to augmented reality (AR) systems and methods for improving power and performance in AR rendering pipelines using super resolution techniques. These aspects address the challenges by improving the AR pipeline with the use of super resolution techniques. By rendering content at a lower resolution and then applying super resolution techniques to upscale the content, the solution achieves significant power savings and improved performance.

Super resolution, in the context of GPU-based computer graphics rendering, is a technique to enhance the resolution of rendered images, making the images appear sharper and more detailed. This enhancement is achieved by reconstructing high resolution images from low resolution inputs using parallel processing capabilities of GPUs. Well-known super resolution techniques in this domain include bicubic interpolation, which is simple and fast but may result in blurry images. Convolutional neural networks (CNNs) leverage large datasets to significantly improve image quality. Generative adversarial networks (GANs) train two neural networks in tandem to produce and refine high-resolution images. Additionally, transformers, which use attention mechanisms to capture long-range dependencies in images, may be employed for highly detailed reconstructions. Some well-known techniques are deep learning super sampling (DLSS) from Nvidia Corporation, fidelity super resolution (FSR) from AMD Corporation, and Xe super sampling (XeSS) from Intel Corporation.

Some techniques of the present disclosure reduce the computational load during the initial rendering and composition stages, while still delivering high quality visual output through upscaling. These techniques not only conserve power but also enhance the overall performance of AR systems, making them more feasible for prolonged use, and improving the user experience.

The techniques of the present disclosure start with rendering content at a lower resolution, (e.g., two times lower than a standard resolution), thereby saving power. Some techniques then perform low resolution composition of the low resolution layers. Warping and various distortion corrections may also occur at this stage. Super resolution techniques, including spatial and/or temporal super resolution processing are applied. Finally, display processing of the upscaled image occurs to ensure generated image is calibrated to match the display space with chromatic aberration correction, white point correction, and gamma correction, for example.

Significant power savings are thus achieved during rendering and composition, allowing a reduced power budget for composition and display processing. Further power savings may be achieved by implementing super resolution in an application specific integrated circuit (ASIC). As a result of the power savings, performance and motion-to-photon coupling may be improved, in other words, motion-to-photon latency may be reduced. The techniques may be applied in AR glasses and headsets, mobile AR devices, and any AR system specifying efficient power management.

Aspects of the present disclosure introduce processes to optimize power and performance in AR systems by leveraging super resolution techniques. These aspects address the need for efficient power management while maintaining high quality visual output, making AR devices more feasible for prolonged use.

An augmented reality (AR) content processing pipeline renders and composes multiple surfaces. AR systems are expected to render or generate various types of content onto individual or merged layers or surfaces at different rates. The various types of content are displayed on a display device. The content can be head-locked, world-locked, etc. The layers may be sparsely populated in the final display buffer. Moreover, layer visibility is placement dependent. That is, layers can be transparent and/or overlapping depending on visibility, placement, and user orientation. Sparse and overlapping content-based composition would be more efficient if the processing (e.g., warping, corrections, etc.) is performed on an overall smaller number of pixels. Upscaling after composition in the display buffer, instead of per layer upscaling, may provide further power saving opportunities.

Average or heavily used AR applications are expected to perform rendering locally in the glasses or headset. Low rate, high complexity content may be rendered on a remote processing device, such as a puck-shaped component. For prolonged battery use and an overall lower power budget for these AR systems, power savings during rendering, composition, and wireless transfer is important for the AR device to be feasible.

Content generation may include rendering two-dimensional (2D), two-and-a-half-dimensional (2.5D), three-dimensional (3D), or other types of content. Content generation may also include capturing or processing images with a camera. These types of content generation consume significant amounts power. Saving power during content generation would help save power in an AR pipeline. A lower number of pixels rendered results in lower overall power consumption. Thus, multi-surface rendering at a reduced resolution would be beneficial.

In many cases, a display rate is higher than a rendering rate. In some aspects, the AR device may render at a lower rate than specified. In these aspects, in-between frames may be generated to match the rendering rate to the display rate, providing additional power savings.

Transmission power may be reduced if rendering occurs at lower resolution with a local graphics processing unit (GPU) instead of at a more powerful remote processor (e.g., a handheld puck-like device). Local rendering reduces puck-to-glass transfer of contents. After rendering locally, the composing may also be performed locally.

Multiple techniques for improving power and performance in an AR video processing pipeline will now be described with respect to FIGS. 2 and 3.

FIG. 2 is a block diagram illustrating a first augmented reality (AR) content processing pipeline, in accordance with various aspects of the present disclosure. The pipeline may be implemented with hardware, software or a combination of hardware and software. In the example of FIG. 2, the AR video processing pipeline includes a systems application (Sys App), a first application (App 1), a second application (App 2), and a third application (App 3). At block 202, content from the systems application (Sys App), first application (App 1), and second application (App 2) is rendered in a GPU, such as the GPU 104 of FIG. 1. The third application (App 3) provides content, such as from a camera, that is processed but not rendered, at block 204. The rendered content includes lower resolution layers, such as system notifications (e.g., a battery status indicator) 206, coded user interface content 208, and a virtual assistant 210. Each piece of content 206, 208, 210 may be rendered at a different rate and may have different sizes, for example, different widths and/or heights. The rendering may occur at a lower resolution (e.g., two times lower) than full resolution. The non-rendered content may include a camera feed 212, also at a lower resolution. As seen relative to a full resolution layer 216, lower resolution layers 218 (including the rendered and non-rendered content 206, 208, 210, 212) are at a lower scale. Depth, color, and motion vectors (MV) 214 (along with other types of supporting information) are also rendered at a lower scale. The lower resolution processing saves power. Some content may be head-locked, whereas other content may be world-locked. By rendering the camera feed 212 and world/head-locked content 206, 208, 210 at a lower resolution, power savings is achieved.

A composition engine 220 may compose the low resolution layers or surfaces of the content 206, 208, 210, 212 at the lower resolutions. The low resolution layers or surfaces may or may not be merged during the composition. The composing may occur at a higher frame rate than the rendering rate. Warping, various distortion corrections (e.g., lens distortion correction (LDC), rolling shutter corrections, etc.), and other types of processing may occur before final super resolution processing, at block 230, in order to generate multiple frames of images 222, 224, 226.

At block 230, super resolution processing occurs. The super resolution processing at block 230 receives merged depth information, composed color information, and merged motion vectors 228, as well as other types of supporting information. The super resolution processing at block 230 also receives the warped frames of images 222, 224, 226. Super resolution processing may include spatial and/or temporal upscaling in order to upscale the warped images 222, 224, 226. That is, the rendering rate may be increased, as well as the resolution. As seen at a full resolution layer 232, the low resolution content 234 is upscaled. Geometric distortion corrections, such as rolling shutter correction, etc., are applied once the frame buffer for display is generated. By composing before super resolution processing, the overall image is known (e.g., what portions are not seen because they are behind another image) and unnecessary upscaling of unseen images is prevented.

A display processing unit (DPU) 240 applies display correction techniques on upscaled display buffer content 242 received from the super resolution block 230. Display correction techniques may include geometry corrections such as lens aberration correction, rolling shutter correction, etc. and may also include one or more color correction techniques such as gamma correction, white point correction, gamut correction, chromatic aberration correction (CAC), etc. Several display corrections may occur to attain a desired visual quality. However, ultralow power use-cases may employ only a few or no such post processing steps at the cost of imperfect visual representation with improved performance gain for unit power. The DPU 240 outputs a final image 244 for display to the user.

For temporal scaling (e.g., rate increasing), such as new frames generated using super resolution, various distortion corrections may occur after the super resolution processing at block 230, instead of by the composition engine 220. Similarly, other display processing steps (e.g., white point correction, gamma correction, etc.) can be performed before super resolution at block 230, instead of at the DPU 240.

Rendering power savings due to rendering at a significantly lower rate improves performance and guarantees better motion-to-photon coupling. Composition processing, including warping at a much lower size, reduces the composition power budget, in addition to improving performance. That is, if composition (which includes warping and correcting distortions) occurs before super resolution-based upscaling, fewer pixels are processed during the composition steps, as each layer is handled separately. After composition, only one image is upscaled using super resolution techniques. Conversely, if each layer is upscaled first, the overall processing cost (in terms of performance and power) for super resolution is much higher, and composing these larger layers afterward also significantly increases the composition cost. The improved performance of composing before super resolution processing produces better correlation between rendering and composition. To further improve power and performance savings, the super resolution processing at block 230 may be implemented in an ASIC, instead of a GPU.

FIG. 3 is a block diagram illustrating another augmented reality (AR) content processing pipeline, in accordance with various aspects of the present disclosure. The pipeline may be implemented with hardware, software or a combination of hardware and software. In the example of FIG. 3, rendering occurs at a lower resolution and then upscaling or uprating occurs before composition.

In the example of FIG. 3, the AR video processing pipeline includes a systems application (Sys App), a first application (App 1), a second application (App 2), and a third application (App 3). At block 302, content from the systems application (Sys App), first application (App 1), and second application (App 2) is rendered in a GPU, such as the GPU 104 of FIG. 1. The third application (App 3) provides content, such as from a camera, that is processed but not rendered, at block 304. The rendered content includes lower resolution layers, such as system notifications (e.g., a battery status indicator) 306, coded user interface content 308, and a virtual assistant 310. Each piece of content 306, 308, 310 may be rendered at a different rate and may have different sizes, for example, different widths and/or heights. The rendering may occur at a lower resolution (e.g., two times lower) than full resolution. The non-rendered content may include a camera feed 312 that may also be provided at a lower resolution. As seen relative to a full resolution layer 316, lower resolution layers 318 are at a lower scale. Depth, color, and motion vectors (MV) 314 are also rendered at a lower scale (along with other types of supporting information). The lower resolution rendering saves power. By rendering the camera feed 312 and world/head-locked content 306, 308, 310 at a lower resolution, power savings is achieved.

Super resolution processing occurs at block 320. That is, super resolution-based spatial and/or temporal upscaling are applied to upscale the lower resolution layers 318 to the full resolution layer 316. The super resolution processing at block 320 receives corollary information, for example the depth information, color information, and motion vectors 314, along with the lower resolution layers 318. Content-based selective spatial upscaling may be performed. In addition, variable rate content-based temporal upscaling may also be achieved. The super resolution processing may occur in a GPU shader within the AR device. By performing super resolution processing before composition, corrections at a smaller scale may be prevented. Moreover, composition on temporally upscaled content can be even more costly, because composing occurs at a display rate or higher than a render rate if composition occurs after post super resolution processing.

Composition and display processing can be performed without any major changes. More specifically, a composition engine 330 composes the layers/surfaces of the content regardless of whether the content is merged. The content is warped and lens distortion is corrected to generate display buffer content 342. A DPU 340 applies chromatic aberration correction (CAC), white point correction, non-uniformity correction, and, if needed, gamma correction, etc., on the display buffer content 342. Other corrections may also occur, such as gamut mapping, for example. The DPU 340 outputs a final image 344 for display to the user after performing the corrections.

Due to rendering at a lower rate, power savings is achieved during rendering. Improved performance guarantees better motion-to-photon coupling. For temporal scaling (e.g., new frames generated using super resolution), various content may be rendered at various rates and then upscaled as necessary, thereby improving power efficiency as well as performance.

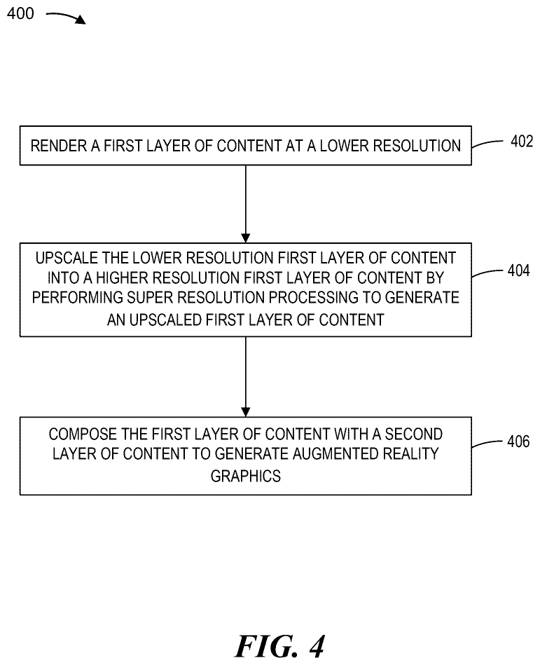

FIG. 4 is a flow diagram illustrating an example process 400 performed, for example, by a compute device, in accordance with various aspects of the present disclosure. The example process 400 is an example of augmented reality (AR) content processing. As shown in FIG. 4, in some aspects, the process 400 may include rendering a first layer of content at a lower resolution (block 402). In some aspects, the process 400 may include upscaling the lower resolution first layer of content into a higher resolution first layer of content by performing super resolution processing to generate an upscaled first layer of content (block 404). For example the upscaling may include upscaling a second layer of content to generate an upscaled second layer of content such that low resolution composing generates low resolution augmented reality graphics based on the lower resolution first layer of content and the second layer of content, which is at the lower resolution. The upscaling may comprise content-based selective spatial upscaling and/or variable rate content-based temporal upscaling.

In some aspects, the process 400 may include composing the first layer of content with a second layer of content to generate augmented reality graphics (block 406). The composing may comprises low resolution composing that occurs before the upscaling. Alternatively, the composing occurs after the upscaling, and the upscaling comprises upscaling the second layer of content into a higher resolution second layer of content by applying super resolution processing to generate an upscaled second layer of content, and the composing further comprises composing the upscaled second layer of content with the upscaled first layer of content.

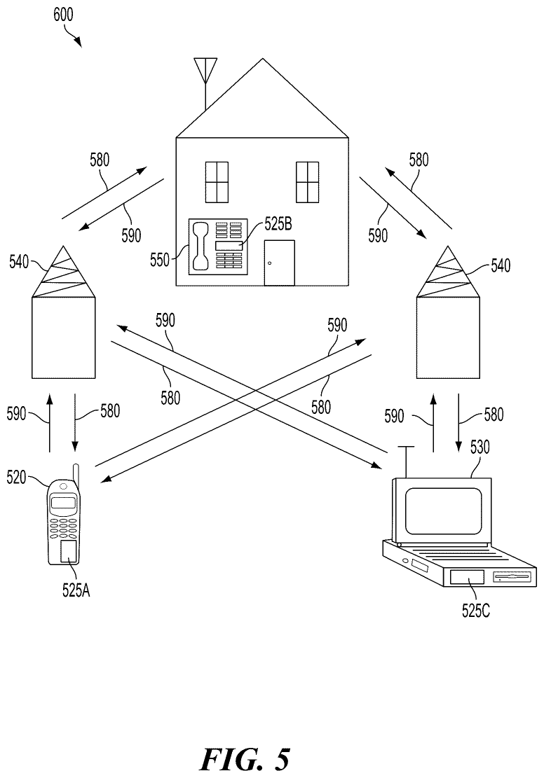

FIG. 5 is a block diagram showing an exemplary wireless communications system 500, in which an aspect of the present disclosure may be advantageously employed. For purposes of illustration, FIG. 5 shows three remote units 520, 530, and 550, and two base stations 540. It will be recognized that wireless communications systems may have many more remote units and base stations. Remote units 520, 530, and 550 include integrated circuit (IC) devices 525A, 525B, and 525C that include the disclosed video processing pipeline. It will be recognized that other devices may also include the disclosed video processing pipeline, such as the base stations, switching devices, and network equipment. FIG. 5 shows forward link signals 580 from the base stations 540 to the remote units 520, 530, and 550, and reverse link signals 590 from the remote units 520, 530, and 550 to the base stations 540

In FIG. 5, remote unit 520 is shown as a mobile telephone, remote unit 530 is shown as a portable computer, and remote unit 550 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 5 illustrates remote units according to the aspects of the present disclosure, the disclosure is not limited to these exemplary illustrated units. Aspects of the present disclosure may be suitably employed in many devices, which include the disclosed video processing pipeline.

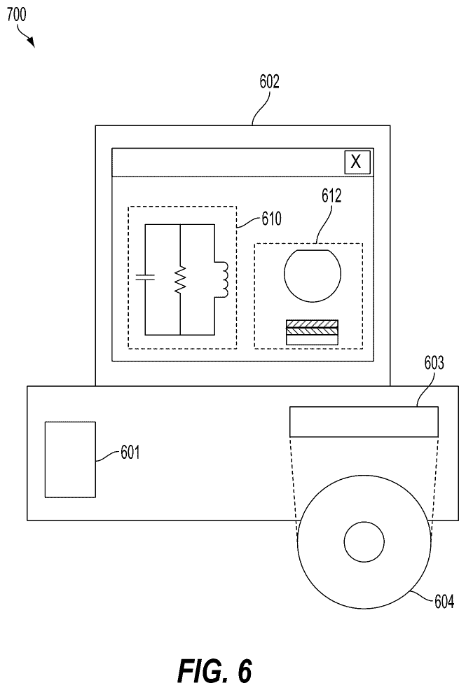

FIG. 6 is a block diagram illustrating a design workstation 600 used for circuit, layout, and logic design of a semiconductor component, such as the video processing pipeline disclosed above. The design workstation 600 includes a hard disk 601 containing operating system software, support files, and design software such as Cadence or OrCAD. The design workstation 600 also includes a display 602 to facilitate design of a circuit 610 or a semiconductor component 612, such as the video processing pipeline.

A storage medium 604 is provided for tangibly storing the design of the circuit 610 or the semiconductor component 612 (e.g., the PLD). The design of the circuit 610 or the semiconductor component 612 may be stored on the storage medium 604 in a file format such as GDSII or GERBER. The storage medium 604 may be a CD-ROM, DVD, hard disk, flash memory, or other appropriate device. Furthermore, the design workstation 600 includes a drive apparatus 603 for accepting input from or writing output to the storage medium 604.

Data recorded on the storage medium 604 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 604 facilitates the design of the circuit 610 or the semiconductor component 612 by decreasing the number of processes for designing semiconductor wafers.

### EXAMPLE ASPECTS

Aspect 1: A computer implemented method, comprising: rendering a first layer of content at a lower resolution; upscaling the lower resolution first layer of content into a higher resolution first layer of content by performing super resolution processing to generate an upscaled first layer of content; and composing the first layer of content with a second layer of content to generate augmented reality graphics.
Aspect 2: The method of Aspect 1, in which: the composing comprises low resolution composing that occurs before the upscaling; and the upscaling further includes upscaling the second layer of content to generate an upscaled second layer of content such that the low resolution composing generates low resolution augmented reality graphics based on the lower resolution first layer of content and the second layer of content, which is at the lower resolution.
Aspect 3: The method of Aspect 1 or 2, further comprising: correcting distortion in the augmented reality graphics; and warping the augmented reality graphics.
Aspect 4: The method of any of the preceding Aspects, further comprising performing geometry correction and/or color correction on the upscaled first layer of content and the upscaled second layer of content after the composing.
Aspect 5: The method of Aspect 1, in which the composing occurs after the upscaling, and the upscaling further comprises upscaling the second layer of content into a higher resolution second layer of content by performing super resolution processing to generate an upscaled second layer of content, and the composing further comprises composing the upscaled second layer of content with the upscaled first layer of content.
Aspect 6: The method of any of the preceding Aspects 1 or 5, in which the upscaling comprises content-based selective spatial upscaling.
Aspect 7: The method of any of the Aspects 1 or 5-6, in which the upscaling comprises variable rate content-based temporal upscaling.
Aspect 8: The method of any of the Aspects 1 or 5-7, further comprising performing geometry correction and/or color correction on the augmented reality graphics in a display buffer.
Aspect 9: An apparatus, comprising: at least one memory; and at least one processor coupled to the at least one memory, the at least one processor configured: to render a first layer of content at a lower resolution; to upscale the lower resolution first layer of content into a higher resolution first layer of content by performing super resolution processing to generate an upscaled first layer of content; and to compose the first layer of content with a second layer of content to generate augmented reality graphics.
Aspect 10: The apparatus of Aspect 9, in which the at least one processor is further configured: to compose in low resolution before the upscaling; and to upscale the second layer of content to generate an upscaled second layer of content such that the low resolution composing generates low resolution augmented reality graphics based on the lower resolution first layer of content and the second layer of content, which is at the lower resolution.
Aspect 11: The apparatus of Aspect 9-10, in which the at least one processor is further configured: to correct lens distortion in the augmented reality graphics; and to warp the augmented reality graphics.
Aspect 12: The apparatus of any of the Aspects 9-11, in which the at least one processor is further configured to perform geometry correction and/or color correction on the upscaled first layer of content and the upscaled second layer of content after the composing.
Aspect 13: The apparatus of Aspect 9, in which the at least one processor is further configured to compose after upscaling, and upscale the second layer of content into a higher resolution second layer of content by performing super resolution processing to generate an upscaled second layer of content, and compose the upscaled second layer of content with the upscaled first layer of content.
Aspect 14: The apparatus of any of the Aspects 9 or 13, in which the at least one processor is further configured to content-based selective spatial upscale.
Aspect 15: The apparatus of any of the Aspects 9 or 13-14, in which the at least one processor is further configured to variable rate content-based temporal upscale.
Aspect 16: The apparatus of any of the Aspects 9 or 13-15, in which the at least one processor is further configured to perform geometry correction and/or color correction on the augmented reality graphics in a display buffer.
Aspect 17: A non-transitory computer-readable medium having program code recorded thereon, the program code executed by a processor and comprising: program code to render a first layer of content at a lower resolution; program code to upscale the lower resolution first layer of content into a higher resolution first layer of content by performing super resolution processing to generate an upscaled first layer of content; and program code to compose the first layer of content with a second layer of content to generate augmented reality graphics.
Aspect 18: The non-transitory computer-readable medium of Aspect 17, in which the program code comprises: program code to low resolution compose before the upscaling; and program code to upscale the second layer of content to generate an upscaled second layer of content such that the low resolution composing generates low resolution augmented reality graphics based on the lower resolution first layer of content and the second layer of content, which is at the lower resolution.
Aspect 19: The non-transitory computer-readable medium of Aspect 17 or 18, in which the program code comprises: program code to correct lens distortion in the augmented reality graphics; and program code to warp the augmented reality graphics.
Aspect 20: The non-transitory computer-readable medium of any of the Aspects 17-19, in which the program code comprises: program code to perform geometry correction and/or color correction on the upscaled first layer of content and the upscaled second layer of content after the composing.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

1. A computer implemented method, comprising:
rendering locally at an augmented reality (AR) device, a first layer of content at a lower resolution and a second layer of content;
upscaling at the AR device, the lower resolution first layer of content into a higher resolution first layer of content by performing super resolution processing to generate an upscaled first layer of content;
upscaling at the AR device, the second layer of content by performing super resolution processing to generate an upscaled second layer of content; and
composing at the AR device, the upscaled first layer of content with the upscaled second layer of content to generate augmented reality graphics.

2. The method of claim 1, in which:
the composing comprises low resolution composing that occurs before the upscaling; and
the upscaling further includes upscaling the second layer of content to generate an upscaled second layer of content such that the low resolution composing generates low resolution augmented reality graphics based on the lower resolution first layer of content and the second layer of content, which is at the lower resolution.

3. The method of claim 2, further comprising:
correcting distortion in the augmented reality graphics; and
warping the augmented reality graphics.

4. The method of claim 1, further comprising performing geometry correction and/or color correction on the upscaled first layer of content and the upscaled second layer of content after the composing.

5. (canceled)

6. The method of claim 1, in which the upscaling comprises content-based selective spatial upscaling.

7. The method of claim 1, in which the upscaling comprises variable rate content-based temporal upscaling.

8. The method of claim 1, further comprising performing geometry correction and/or color correction on the augmented reality graphics in a display buffer.

9. An apparatus, comprising:
at least one memory; and
at least one processor coupled to the at least one memory, the at least one processor configured:
to render, locally at an augmented reality (AR) device, a first layer of content at a lower resolution and a second layer of content;
to upscale, at the AR device, the lower resolution first layer of content into a higher resolution first layer of content by applying super resolution processing to generate an upscaled first layer of content;
to upscale, at the AR device, the second layer of content by applying super resolution processing to generate an upscaled second layer of content; and
to compose, at the AR device, the upscaled first layer of content with the upscaled second layer of content to generate augmented reality graphics.

10. The apparatus of claim 9, in which the at least one processor is further configured:
to compose in low resolution before the upscaling; and
to upscale the second layer of content to generate an upscaled second layer of content such that the low resolution composing generates low resolution augmented reality graphics based on the lower resolution first layer of content and the second layer of content, which is at the lower resolution.

11. The apparatus of claim 10, in which the at least one processor is further configured:
to correct lens distortion in the augmented reality graphics; and
to warp the augmented reality graphics.

12. The apparatus of claim 9, in which the at least one processor is further configured to perform geometry correction and/or color correction on the upscaled first layer of content and the upscaled second layer of content after the composing.

13. (canceled)

14. The apparatus of claim 9, in which the at least one processor is further configured to perform content-based selective spatial upscaling.

15. The apparatus of claim 9, in which the at least one processor is further configured to perform variable rate content-based temporal upscaling.

16. The apparatus of claim 9, in which the at least one processor is further configured to perform geometry correction and/or color correction on the augmented reality graphics in a display buffer.

17. A non-transitory computer-readable medium having program code recorded thereon, the program code executed by a processor and comprising:
program code to render locally at an augmented reality (AR) device, a first layer of content at a lower resolution and a second layer of content;
program code to upscale, at the AR device, the lower resolution first layer of content into a higher resolution first layer of content by performing super resolution processing to generate an upscaled first layer of content;
program code to upscale, at the AR device, the second layer of content by performing super resolution processing to generate an upscaled second layer of content; and
program code to compose, at the AR device, the upscaled first layer of content with the upscaled second layer of content to generate augmented reality graphics.

18. The non-transitory computer-readable medium of claim 17, in which the program code comprises:
program code to perform low resolution composition before the upscaling; and
program code to upscale the second layer of content to generate an upscaled second layer of content such that the low resolution composing generates low resolution augmented reality graphics based on the lower resolution first layer of content and the second layer of content, which is at the lower resolution.

19. The non-transitory computer-readable medium of claim 18, in which the program code comprises:
program code to correct lens distortion in the augmented reality graphics; and
program code to warp the augmented reality graphics.

20. The non-transitory computer-readable medium of claim 17, in which the program code comprises:
program code to perform geometry correction and/or color correction on the upscaled first layer of content and the upscaled second layer of content after the composing.
